(19) United States
(12) Patent Application Publication
(10) Pub. No.: US 2016/0098873 A1
(43) Pub. Date: Apr. 7, 2016

(54) CLOUD-BASED PHYSICAL ACCESS CONTROL SYSTEM HAVING AN EXPANDABLE WIRELESS NETWORK

(71) Applicant: Joshua Perry, Sandy, UT (US)

(72) Inventor: Joshua Perry, Sandy, UT (US)

(21) Appl. No.: 14/877,778

(22) Filed: Oct. 7, 2015

Related U.S. Application Data
(60) Provisional application No. 62/061,034, filed on Oct. 7, 2014.

(51) Int. Cl. G07C 9/00

(52) U.S. Cl. CPC G07C 9/00007; G07C 9/00309; G07C 2009/00769

(57) ABSTRACT

A system and method for implementing an improved physical access control system that may be installed as a new system, installed to upgrade an existing system, or installed to expand an existing system, wherein a door access control system may include a new central processing appliance that may be implemented in software to thereby remove dependence upon hardware, enable implementation as a virtual machine, enable implementation in the cloud to thereby increase access, may include a central I/O controller for the central processing appliance and a new remote I/O controller at each door for handling communications, and wherein the remote I/O controllers may also provide wireless network functionality to enable wireless expansion and improved data integrity of the system.

### BACKGROUND

This invention relates generally to physical access control systems. Specifically, the invention pertains to a new topology and a new architecture for a physical access control system that enables a system to be upgraded without having to run new wires, implements improved connectivity between edge devices and a central controller, enables simple and cost effective expansion of existing systems and centralized control that is easy to modify.

Prior art door access control systems include a first type of system shown in FIG. 1 that relies on hard wiring between a central processing controller 10 and edge devices 12 located at each door 14, where the edge devices may not perform processing or logic functions but instead transmit signals to the central processing controller through at least one wire 16. The central processing controller 10 may include a unique set of relays, memory, processing power and other necessary hardware to make all decisions and control operation of each door 14. In other words, the processing power or logic functions are all contained in the central processing controller 10 and no decisions are made by the edge devices 12.

A typical first type of door access control systems may require X discrete sets of hardware for controlling X different doors 14. However, once X doors have been connected to the central processing controller 10, adding a single new door requires the addition of an entirely new central processing controller 10 that may control 8 to 16 doors 14. Furthermore, any upgrades to the logic of the central processing controller 10 may require replacement of the entire central processing controller, thus making upgrades and expansion difficult and costly.

A second type of door access control system in the prior art and shown in FIG. 2 may also require the installation of at least one wire from each door 14 to a central location. However, all of the hardware and processing power is now pushed to smart edge devices 24 instead of being performed by a central processing controller 10 at a central location. In this door access control system, the central location 20 may have nothing more than a central hub 22 that may provide power distribution using Power-over-Ethernet (POE) and Ethernet cables. This second door access control system may also require more connections between the doors 12 themselves so that all of the smart edge devices 24 are aware of the status of all the other smart edge devices.

Some of the disadvantages of this second type of system include, but should not be considered as limited to, requiring at least one wire 16 from the central location 20 to each door 14, having all the processing power and logic functions distributed at each door 14 without any central controller, having no easy way to expand the system without installing more wires to new doors, having no other way to expand the system other than buying expensive smart edge devices 24, and only being able to modify the functionality of the smart edge devices by replacing each smart edge device.

These and other embodiments of the present will become apparent to those skilled in the art from a consideration of the following detailed description taken in combination with the accompanying drawings.

### BRIEF SUMMARY

The present invention is a system and method for implementing an improved physical access control system that may be installed as a new system, installed to upgrade an existing system, or installed to expand an existing system, wherein the physical access control system may include a new central processing appliance that may be implemented in software to thereby remove dependence upon hardware, enable implementation as a virtual machine, enable implementation in the cloud to thereby increase access, may include a central I/O controller for the central processing appliance and a new remote I/O controller at each door for handling communications, and wherein the remote I/O controllers may also provide wireless network functionality to enable wireless expansion and improved data integrity of the system.

### BRIEF DESCRIPTION OF THE SEVERAL VIEWS OF THE DRAWINGS

FIG. 1 is an illustration of a prior art door access control system illustrating a first topology.

FIG. 2 is an illustration of a prior art door access control system illustrating a second topology.

FIG. 3 is a block diagram of an overall architecture for the embodiments of a door access control system.

FIG. 4 is an illustration of a first embodiment of a door access control system.

FIG. 5 is an illustration of a first embodiment of a door access control system where the central processing appliance may be implemented on computer hardware at a remote location.

FIG. 6 is an illustration of a door including a plurality of edge devices that are all coupled to a remote I/O unit that communicates with the central processing appliance through a central I/O unit.

FIG. 7 is an illustration of a modification of the first embodiment that illustrates the addition of new doors to the door access control system.

FIG. 8 is an illustration of a second embodiment of a door access control system that only uses a wireless network for communication between doors and a central processing appliance.

FIG. 9 is an illustration of how logical domains might be divided up among different components of the door access control system.

### DETAILED DESCRIPTION

Reference will now be made to the drawings in which the various embodiments will be given numerical designations and in which the embodiments will be discussed so as to enable one skilled in the art to make and use the embodiments of the disclosure. It is to be understood that the following description illustrates embodiments of the present disclosure, and should not be viewed as narrowing the claims which follow.

The embodiments of the present invention are shown providing access control for doors. However, the invention may be used to control access to any system, either physical or electronic. Accordingly, the terms “physical access control” “door access control” and “electronic access control” may be used interchangeably throughout this document.

Before addressing a specific embodiments of the invention, it is useful to first discuss what is trying to be accomplished by the present invention. The physical access control system of the present invention is providing a system that provides versatility, robustness, ease of use, ease of upgrading, ease of access and improved fault tolerance when any portion of the system breaks down. This is accomplished by creating logic domains for various sub-systems of the invention.

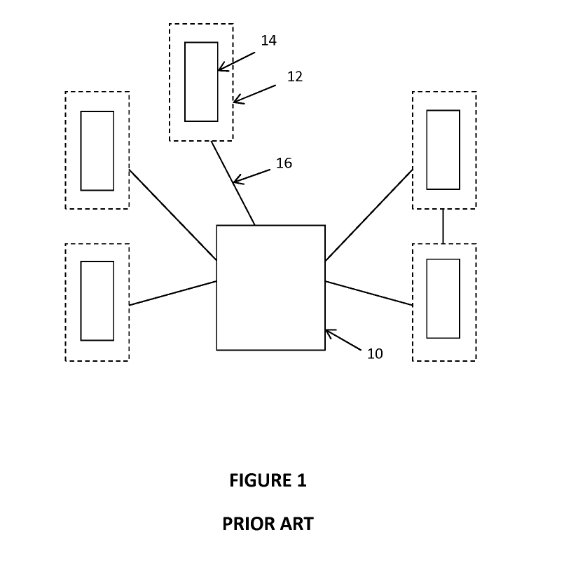

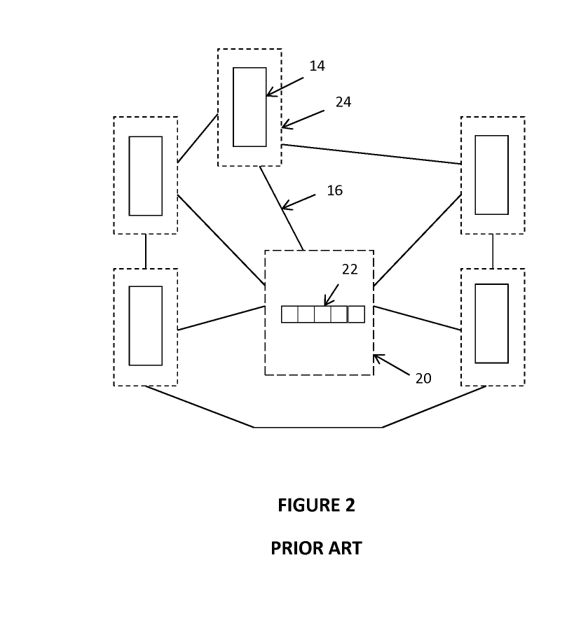

For example, consider the prior art system of FIG. 1. A failure of any part of the system may result in complete failure of the entire system. If the central processing controller 10 fails, then none of the doors 14 may be able to be controlled. Similarly, if any smart edge device 24 in FIG. 2 can no longer process information, then the smart edge device fails and the door may become inoperative.

Accordingly, to provide all of the desired functions of the present invention, it is useful to look at various subsystems as logic domains whose functions (all or part) may be moved to one or more different logic domains if a failure occurs.

The embodiments of the present invention provide more than just redundancy for a physical access control system. By providing the ability to move logic processing from one system to another, and to even split the logic processing between different logic domains, the reliability and the availability of the system is substantially greater than competing systems.

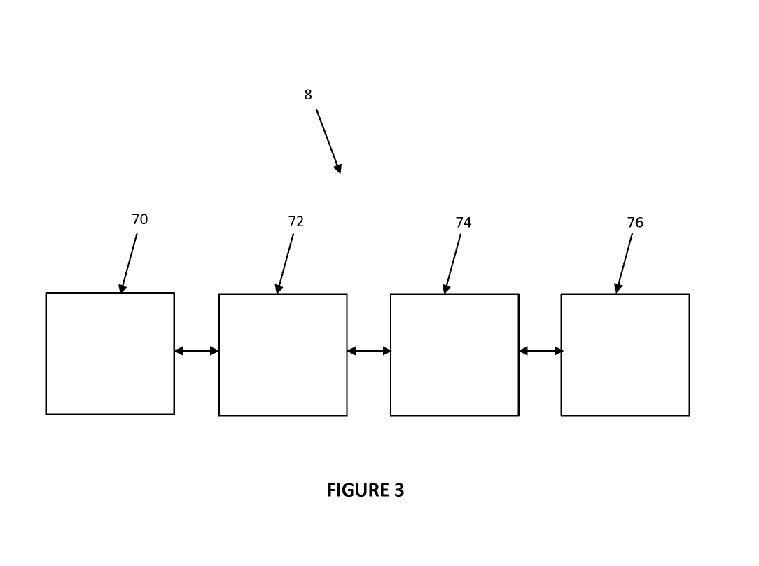

FIG. 3 is provided only as an example of the logic domains 8 that may be a part of all the embodiments of the present invention. For example, the first logic domain may be a cloud-based controller and database 70. The next logic domain may be a central processing appliance 72. The next logic domain may be a door I/O controller 74, and the last logic domain may be a plurality of edge devices 76. The example of FIG. 3 shows four logic domains 8. However, there may be more or fewer logic domains 8 and the invention should not be considered to be limited to just four logic domains.

As an example only, consider the failure of the central processing appliance 72. The functions of that logic domain may be pushed to the door I/O controller 74 while the central processing appliance 72 is not functioning. In this way, the goal of fault tolerance and redundancy is met by one logic domain taking over the functions of another that has failed. Other examples will be given in specific embodiments to be discussed in the figures that follow.

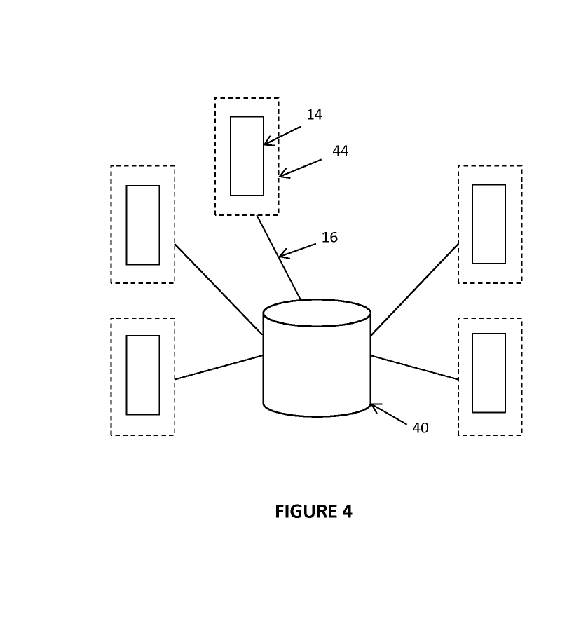

A first embodiment of a door access control system is shown in FIG. 4. A first aspect of the first embodiment is that a central processing controller is now replaced with a central processing appliance 40. This name change reflects a change in the implementation of the central device. The central processing appliance 40 may now be implemented in software or firmware, and may not be restricted by hardware or location.

Some aspects of this change to the central processing appliance 40 may include the ability to make changes to the logic or decision making processes of a door access control system by making changes to a software program instead of replacing or adding hardware, thus making upgrades or modifications much more cost effective, rapid and easier to implement.

Another aspect is that expansion of a door access control system may no longer be a matter of adding additional processing power, memory, relays or other hardware to the central processing appliance 40. Changes may now be implemented by the modification of existing code and/or the addition of new code to the door access control system program in order to communicate with additional doors 14.

Another aspect is that the central processing appliance 40 of the first embodiment may now be implemented as a virtual device. In other words, the door access control program may be running on a general purpose processing device. The general purpose processing device may be a computer server or a computer workstation that is located in a central location as shown in FIG. 4. It should be noted that the edge devices 44 are also not the same edge devise shown in the prior art, and will be described in more detail below.

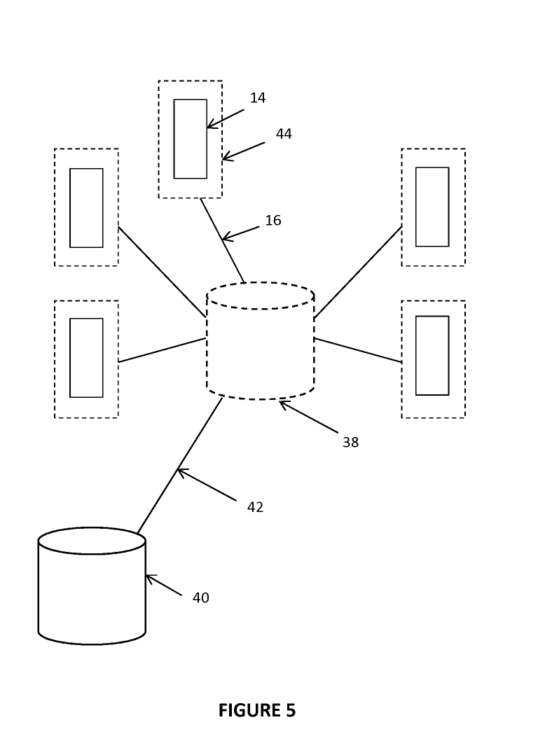

Alternatively, the central processing appliance 40 may not be disposed at the physical location where the doors 14 are located. For example, the central processing appliance 40 may be implemented on computer hardware at a remote location as shown in FIG. 5. For example, the central processing appliance 40 may be a cloud-based virtual device that remotely providing logic and control functions. The central processing appliance 40 may therefore not be physically located anywhere near the actual doors 14 that are being controlled.

The door access control system of the first embodiment may require Internet access 42 or access to some other network such as a cellular network or an in-house dedicated network in order to be implemented using a cloud-based design or some other design where the central processing appliance 40 is not running on a device at the central location 38. Accordingly, the central location 38 may be a communication interface that allows communication from the central processing appliance 40 to access a physical facility where the doors 14 are located.

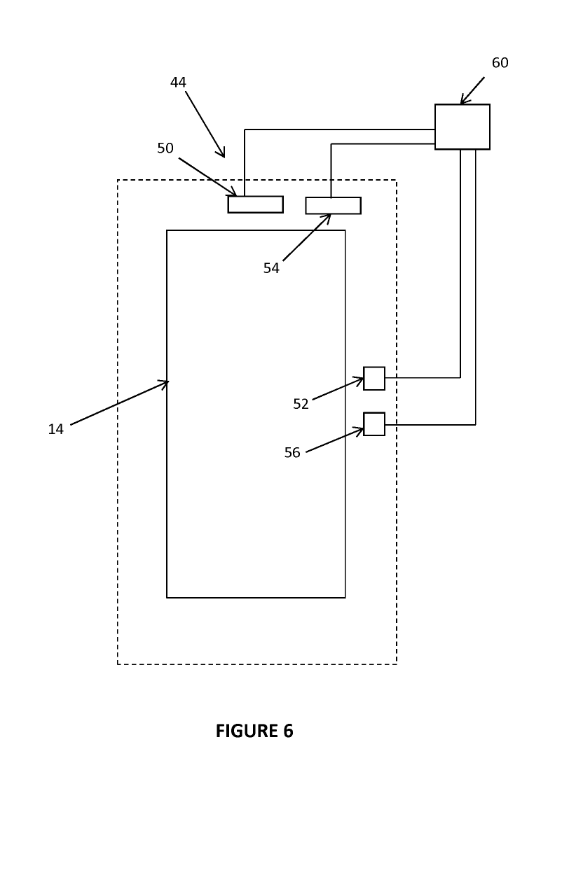

If the central processing appliance 40 is not physically located near the doors 14 being controlled, then the first embodiment may provide a central I/O controller 60 (FIG. 6) that is capable of communicating with edge devices 44 and with the central processing appliance 40, as will be explained.

As shown in FIG. 6, the central processing appliance may use an I/O controller to communicate with edge devices 44 located at each door 14. Edge devices 44 may be defined herein as any device that is located at a door and which is controlled by the central processing appliance 40. Edge devices 44 may perform any function of a door access control system.

Some examples of functions that may be performed by edge devices include but should not be considered as limited to, relays, door position sensors 50, card readers 52, request to exit sensors 54, door latches 56, and any other device that is or may currently be used at a door to control the function of the door.

In the prior art, there may have been one or more wires that went from each edge device all the way to the central processing controller. Another aspect of the first embodiment is that the large number of wires, at least one for each edge device, is no longer necessary. Communication between edge devices 44 and the central processing appliance 40 may be performed by a remote I/O unit 60 located at each door and a central I/O controller 36 that may be used to enable communications with the central processing appliance 40.

For example, the remote I/O unit 60 may receive signals from the edge devices 44 at a door 14 and then transmit the signals to the central I/O controller 36 of the central processing appliance 40. Similarly, the central processing appliance 40 may transmit signals to the edge devices 44 by transmitting signals from the central I/O controller 36 to the remote I/O controller 60. The central I/O controller 36 may be a physical part of the central processing appliance 40 or it may be a logical part. For example, if the central processing appliance 40 is implemented as a cloud-based system, the central I/O controller 36 may be located at the central location 38 adjacent to the doors 14.

The function of the remote I/O controller 60 may include receiving and transmitting signals, but may also include translating signals from analog to digital and from digital to analog. For example, edge devices 44 may not need to be replaced or modified in any way when the central processing appliance 40 replaces a central processing controller of the prior art. The edge devices 44 may continue to transmit analog signals which may now be sent to a local remote I/O controller 60 near a door 14, convert to analog signal to a digital signal, and then transmit the digital signal to the central I/O controller 36 for processing.

The remote I/O controller 60 is a new hardware device that may need to be installed at each door 14. In another aspect of the first embodiment, the remote I/O controller 60 may include other functionality. For example, the remote I/O controller 60 may include a wireless network capability to communicate with a wireless network. The wireless network capability of the present invention is another means by which the embodiments of the invention provide improved fault tolerance and redundancy.

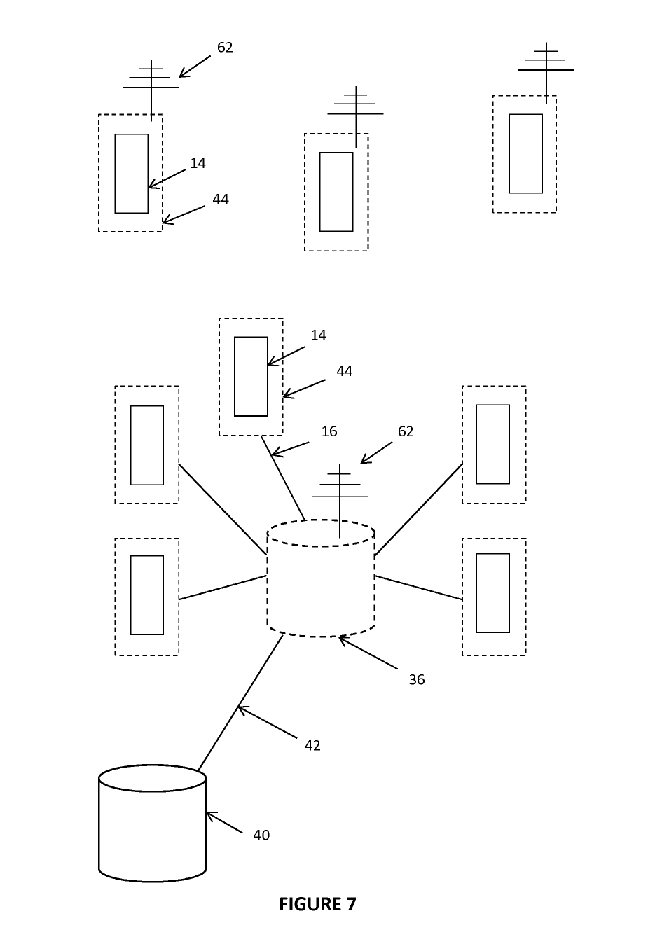

FIG. 7 is provided as an illustration of using a wireless network 62 to expand the number of doors 14 that are being controlled by the central processing appliance 40. The wireless network 62 may be comprised of a wireless network transceiver and antenna at each device that is communicating. A first implication of having a wireless network connection in the remote I/O controller 60 is that the door access control system may be expanded far beyond the limits of existing wires to doors. In other words, while the prior art is limited to controlling doors that have at least one wire between the door and a central location, the first embodiment may be expanded to control any number of doors 14 regardless of the existence of wires. Each door 14 may need a remote I/O controller 60 that is wired to each of the edge devices 44 at the door, but the remote I/O controller will transmit to and receive all data from the central processing appliance 40 for all the edge devices located at the door.

It should be understood that when a door access control system is being expanded by the first embodiment, that means that the existing controller system is being replaced and that it is the invention as shown in the first embodiment that is expanded and not the existing system.

Another aspect of having a wireless network connection 62 is that each of the remote I/O controllers 60 may function as a repeater. Accordingly, the wireless network may have increased transmission redundancy ensuring the integrity of all data sent and received by each remote I/O controller 60. It should also be understood that the door access control system may still be implemented as a completely wired design, may be completely wireless, or may be a combination of wired and wireless at the same time. What is important is that any existing door access control system may be replaced or expanded without limitation. Furthermore, any existing edge devices do not have to be changed but instead may all be integrated into a door access control system using the central processing appliance 40, the central I/O controller 36 and the remote I/O controllers 60 described in the first embodiment.

Another aspect of the first embodiment is that there are many upgrades to functionality of the door access control system that do not require changes in hardware. For example, a change in functionality may be to change the time that must elapse before an alarm is triggered that indicates that a door 14 has been propped open. The door access control system may allow 60 seconds to elapse before an alarm is triggered. However, the user of the system may desire to shorten the time period before an alarm is triggered for a particular door. This change may be implemented by making a change to the programming of the system. No hardware must be modified or added in order to implement this change. The change may be a modification of existing code in the central processing appliance 40.

In addition, simple or complicated changes may be made to alarm conditions, timers, alarms that are triggered, events that trigger alarms, etc. by simply changing the program that is operating the door access control system. These upgrades or modifications to the door access control system should not be considered as limiting but only examples of the numerous changes that may be made by simply changing the program of the door access control system.

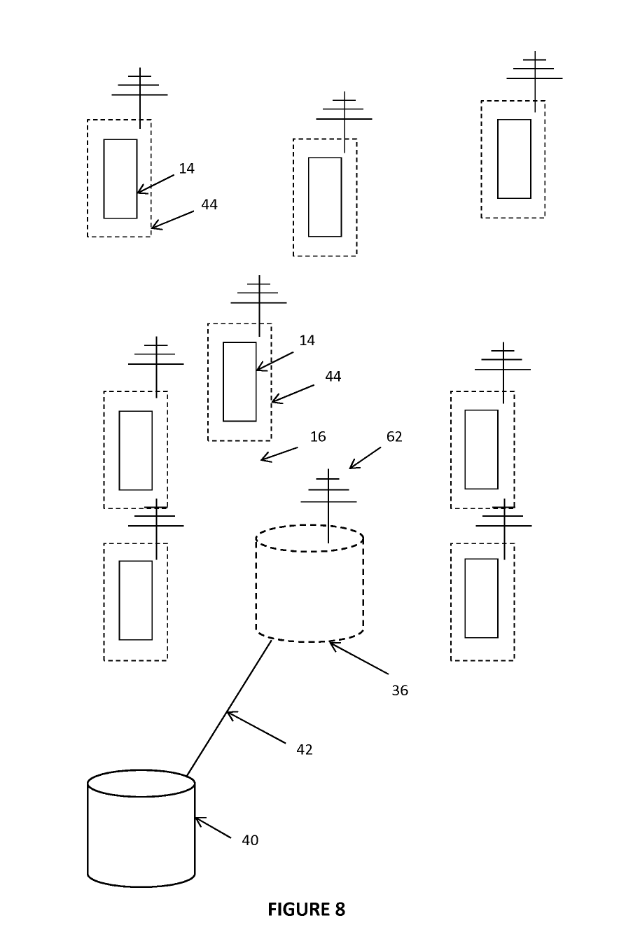

FIG. 8 is a second embodiment of the door access control system. This second embodiment may use a completely wireless topology where there are no wires from the central processing appliance 40 to any edge devices 44. In this second embodiment, the central processing appliance 40 does not have to be located near the edge devices 44. However, the central I/O controller 36 must be within wireless communication range of at least one of the remote I/O controllers 60 in order to be able to communicate with all of the remote I/O controllers. The central processing appliance 40 must be able to communicate with the central I/O controller 36 in order to transmit and receive signals from the remote I/O controllers 60.

It should be understood that all of the embodiments described above may or may not be used in combination with each other and should be considered as operable together unless expressly stated otherwise.

With these examples of the first and second embodiments of the present invention, the concept of logic domains 8 will be used to demonstrate how to further improve the door access control system of the present invention. It was explained previously that the fault tolerance of the door access control system may be improved using logic domains. Some examples of logic domains may now be shown.

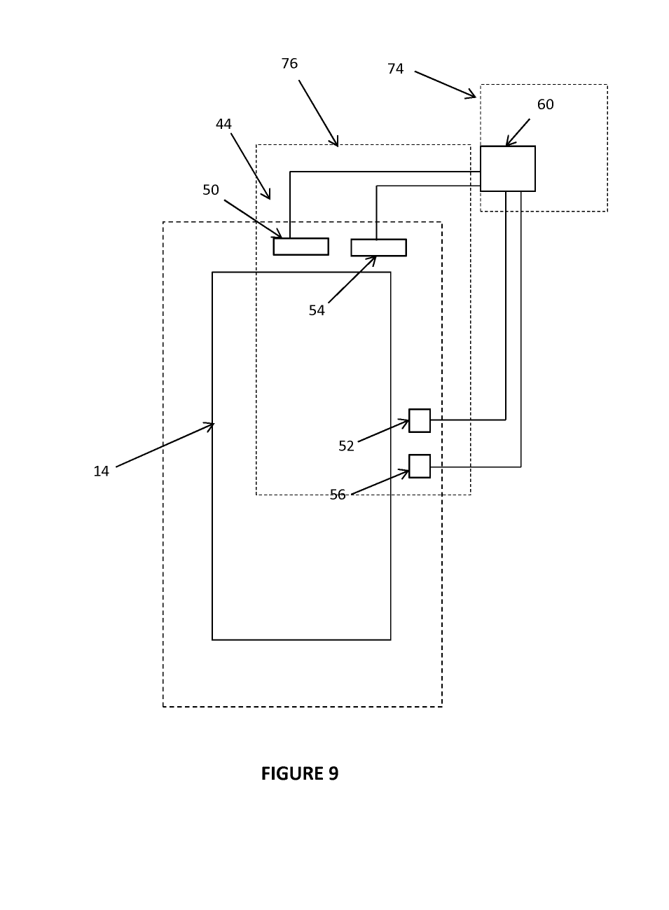

FIG. 9 is an illustration of a typical door 14 with various edge devices 44. The edge devices 44 are now grouped together to form a single domain 76. Similarly, the remote I/O controller 60 is shown as a separate logic domain 74. If the remote I/O controller 60 were to fail, the door would no longer function in the prior art. However, in the embodiments of the present invention, the function of the remote I/O controller 60 might be taken over by the logic domain 76. As long as one of the edge devices 44 included a means of communicating with the central I/O controller 36, then the door 14 could continue operation. If the remote I/O controller 60 was performing any logic or processing functions, then these functions could either be passed to the logic domain 76 or to the logic domain 72. The logic domain 72 is the central processing appliance 40, which may or may not include the central I/O controller 36. Thus, communications functions may be sent to the logic domain 76 and the processing functions may be sent to the logic domain 72. What is important to understand is that communications and processing functions may be passed to another logic domain as long as the other logic domains include those capabilities.

The use of logic domains to control functions of the door access control system enhances fault tolerance of connectivity and data access, latency QOS, easy access to a management interface, global access to the system, the ability to perform fast updates to any part of the system, and to provide security managed service. FIG. 9 should only be considered as one illustration of how the logical domains may be assigned. Furthermore, logical domains may have overlapping physical or virtual devices.

In another example of the usefulness of logic domains, suppose that the central processing appliance 40 may not be able to communicate with some or all of the remote I/O controllers 60. This may happen for various reasons, including but not limited to power outages, damaged cables, or access to a wireless network 62 being cut off. In these situations, it should be understood that the remote I/O controllers 60 may be capable of operating all of the edge devices 44 at a door 14 such that the security of the doors may not be compromised when access to the central I/O controller 36 or the central processing appliance 40 is prevented for any reason.

The central processing appliance 40 may be implemented as a computing device or as a virtual computing device on a physical computing device. The location of the central processing appliance 40 may be any location that gives it access to the doors 14 to be controlled. Thus, the central processing appliance 40 may be located at a facility with the doors 14, or a remote location with communications with the facility with the doors. The central processing appliance 40 may be implemented in the Cloud. In other words, the central processing appliance 40 may be a Cloud-based computing device system as understood by those skilled in the art, where the actual processing and logic functions may be implemented on a server that has access to a network, such as the Internet. The central I/O controller 36 may function as a communications relay between the central processing appliance 40 and the doors 14.

Global access to the fault tolerant physical access control system may be provided in the form of an interface between the central processing appliance 40 and a remote device. The remote device may be a mobile device such as a smart phone or a tablet with access to a network. The remote device may be a desktop or a laptop computer. The remote device may access the central processing appliance at a physical facility or as a Cloud-based device.

Although the preceding description has been described herein with reference to particular means, materials, and embodiments, it is not intended to be limited to the particulars disclosed herein; rather, it extends to all functionally equivalent structures, methods, and uses, such as are within the scope of the disclosure. Accordingly, all such modifications are intended to be included within the scope of this disclosure. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A fault tolerant physical access control system, said system comprising:
a central processing appliance for providing processing and logic functions for a physical access control system;
at least one edge device controlling at least one access function for a door; and
a remote I/O controller adjacent to each door for providing communications between the central processing appliance and the at least one edge device at each door.

2. The physical access control system as defined in claim 1 wherein the system is further comprised of a central I/O controller that enables the central processing appliance to communicate with the remote I/O controller.

3. The physical access control system as defined in claim 2 wherein the system is further comprised of a wireless network transceiver and antenna coupled to each remote I/O controller at each door, and a wireless network transceiver and antenna coupled to the central I/O controller to thereby enable the central processing appliance to communicate with the at least one edge device at each door.

4. The physical access control system as defined in claim 1 wherein the central processing appliance is implemented from the group of central processing appliance comprised of a computing device, a virtual computing device and a Cloud-based computing device.

5. The physical access control system as defined in claim 1 wherein the at least one edge device is selected from the group of edge devices comprised of relays, door position sensors, card readers, request to exit sensors, door latches, and any other device that is or may currently be used at a door to control the function of the door.

6. The physical access control system as defined in claim 1 wherein the system is further comprised of at least one system of communication between the central processing appliance and the remote I/O controller, said system of communication selected from the group of systems of communication comprised of a wired network, a wireless network, and a combination of a wired and a wireless network.

7. A method for providing a fault tolerant physical access control system, said method comprising:
providing a central processing appliance for providing processing and logic functions for a physical access control system;
providing at least one edge device controlling at least one access function for a door; and
providing a remote I/O controller adjacent to each door for providing communications between the central processing appliance and the at least one edge device at each door.

8. The method as defined in claim 7 wherein the method further comprises enabling the central processing appliance to communicate with the remote I/O controller using a central I/O controller.

9. The method as defined in claim 8 wherein the method further comprises providing a wireless network to enable communications between the central processing appliance and the remote I/O controller to thereby improve redundancy of the system.

10. The method as defined in claim 7 wherein the method further comprises implementing the central processing appliance from the group of central processing appliance comprised of a computing device, a virtual computing device and a Cloud-based computing device.

11. The method as defined in claim 7 wherein the method further comprises selecting the at least one edge device from the group of edge devices comprised of relays, door position sensors, card readers, request to exit sensors, door latches, and any other device that is or may currently be used at a door to control the function of the door.

12. The method as defined in claim 7 wherein the method further comprises assigning logical domains to the components of the fault tolerant physical access control system, and enabling different logical domains to perform the functions of other logical domains if any of the logical domains cannot perform its own function.

13. The method as defined in claim 12 wherein the method further comprises assigning the functions of a failed logical domain to one or more other logical domains in order to keep the fault tolerant physical access control system functioning.

14. The method as defined in claim 9 wherein the method further comprises expanding an existing door access control system by adding a remote I/O controller to each door to be added to the system.

15. A method for replacing an existing physical access control system with a fault tolerant physical access control system, said method comprising:
replacing a central processing controller with a central processing appliance for providing processing and logic functions for a fault tolerant physical access control system, including coupling a wireless network transceiver and antenna to the central processing appliance; and
providing a remote I/O controller adjacent to each door, and coupling each edge device to the remote I/O controller at each door for providing communications between the central processing appliance and the at least one edge device at each door by a wired or a wireless connection.
